(19) United States
(12) Patent Application Publication
(10) Pub. No.: US 2008/0310498 A1
(43) Pub. Date: Dec. 18, 2008

(54) Information Recording/Reproducing Apparatus

(75) Inventor: Hiroyuki MARUMORI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/057,410

(22) Filed: Mar. 28, 2008

(30) Foreign Application Priority Data
Jun. 13, 2007 (JP) 2007-156653

(51) Int. Cl. H04B 1/66

(52) U.S. Cl. 375/240.01; 375/E07.001

(57) ABSTRACT

There are provided an information recording/reproducing apparatus and a video camera, both compliant with plural standards and excellent in usability, within an advantageously earlier stage by simplifying a circuit configuration and reducing the development steps and time period. A compression/extension module includes a common compression/extension module which performs a process of a compression method common in plural standards. For example, the common compression/extension module common between the AVCHD standard and the BD standard performs a process of the H.264 compression method for a video signal, and performs a process of the Dolby Digital compression method for an audio signal. A format controlling module includes a common format generating module which performs a formatting process common in plural standards. For example, the common format generating module common between the AVCHD standard and the BD standard generates a format including data structures and directories, in compliance with the BDMV subset.

### CLAIM OF PRIORITY

The present application claims priority from Japanese application serial no. JP 2007-156653, filed on Jun. 13, 2007, the content of which is hereby incorporated by reference into this application.

### BACKGROUND OF THE INVENTION

The present invention relates to an information recording/reproducing apparatus and a video camera apparatus for recording information such as video and audio into disc media.

Recording media mounted into a recent household video camera have been shifted to disc media due to no risk of overwriting and easiness of video search. As recording media, an optical disc such as a DVD and a hard disc (HDD) are used, and products in which semiconductor memories are mounted are beginning to appear on the market. In order to allow the video camera to perform longtime recording and to record video with the high definition, the capacity of recording media has been increased and a high-definition recording method has been advanced.

As large-capacity optical discs, a BD (Blu-ray Disc) of a next-generation optical disc that has been formulated in BDA (Blu-ray Disc Association) and an HD-DVD that is established in the DVD forum appear on the market, and it is anticipated to apply the discs to video cameras for high-definition recording in the future.

On the other hand, as a technique of high definition, a recording function of a high definition (HD) image in place of a conventional standard definition (SD) image has been required. As a recording format used when video data are recorded into a conventional DVD, a management method of video titles and chapters is disclosed in, for example, Japanese Patent Application Laid-Open No. 2003-308675. It was impossible to record an HD image in the conventional DVD standard. However, there has been released the AVCHD (Advanced Video Codec High Definition) standard in which a new coding method is adapted, and it is possible to record an HD image into a conventional DVD. A recording/reproducing technique that enables random access in the AVC/H.264 coding method is disclosed in, for example, Japanese Patent Application Laid-Open No. 2005-348314.

### SUMMARY OF THE INVENTION

As described above, in order to record an HD image by using a video camera, the AVCHD standard in which an HD image can be recorded into a conventional DVD is used, or a BD formulated in BDA is used. It should be noted that the AVCHD standard is supposed to be used when an HD image is recoded into not only a DVD, but also an SD card and an HDD.

As a recording medium, DVDs suffer from its disadvantageous not long shooting period of time. Since the capacity of an 8 cm DVD is 1.4 GB, if an HD image is recorded at 9 Mbps, a shooting period of time is about 20 minutes. It is possible to reduce the rate and to use a two-layered disc. Even in this case, a shooting period of time is about just under 40 minutes. On the other hand, the capacity of an 8 cm BD is about a little over 7 GB, which is fourfold the DVD in the shooting period of time. Accordingly, it is advantageous that a BD is employed for a video camera adapted to HD recording in terms of longtime recording. This fact also applies to an HD-DVD established in the DVD forum.

As described above, a camera that employs a BD of a large-capacity medium is expected as one that meets the demand for high definition and longtime recording. However, it is anticipated that BD-compliant video cameras and AVCHD-compliant video cameras coexist from the time the BD-compliant video cameras are commercialized to the time the BD-compliant video cameras become widespread. When the BD cameras appear on the market, it is convenient if reproducing compatibility with AVCHD is present. Further, since a BD disc is more expensive than a DVD disc, it is more preferable if HD recording can be performed by the BD cameras using an inexpensive DVD. Accordingly, it is desired that the BD camera can be adapted to a DVD disc that is a conventional asset. In other words, it is desired that the BD camera has a function of recording/reproducing compatibility with the AVCHD standard.

Further, a case of a hybrid camera in which an HDD is added and mounted as a recording medium will be assumed. In this case, data on the HDD can be recorded into a BD or a DVD by using a dubbing function. In addition, high-speed data exchange and dubbing between the BD and the DVD becomes easy by using the HDD. By converting data into the DVD format to dub the data to the DVD, the hybrid camera becomes compatible with a conventional DVD player. Further, by converting data into the BD format to record the data into the BD, it is possible to produce a disc with high compatibility with a BD player and a BD recorder. Use of a semiconductor memory such as an SD card and a memory stick in place of the HDD can realize the same function. In these cases, data exchange is performed across plural media and plural standards, so that it is necessary to provide a function adapted to these standards.

In the case of the camera compliant with plural such standards, the provision of individual functions corresponding to the respective standards increases the development steps of the camera and the sizes of circuits, resulting in increased cost.

An object of the present invention is to provide an information recording/reproducing apparatus and a video camera, both compliant with plural standards and excellent in usability, within an advantageously earlier stage by simplifying a circuit configuration and reducing the development steps and time period.

According to the present invention, there is provided an information recording/reproducing apparatus adapted to plural recording media and to record and/or reproduce data in compliance with plural standards. The information recording/reproducing apparatus includes: a compression/extension module which compresses and extends an information signal in compression methods compliant with the plural standards; a format controlling module which generates formats compliant with the plural standards for the information signal; and a recording/reproducing module which records/reproduces the processed data into/from the recoding media. In the information recording/reproducing apparatus, the compression/extension module includes a common compression/extension module which performs a process of a compression method common in the plural standards, and the format controlling module includes a common format generating module which performs a formatting process common in the plural standards.

The information recording/reproducing apparatus further includes a function of copying and moving data among the plural recording media and a function of recording data while performing data conversion compliant with the standards among the plural recording media.

According to the present invention, there is provided a video camera apparatus which records shot video into plural recording media, in compliance with plural standards. The video camera apparatus includes: an imaging module which shoots a subject and obtains a video signal and an audio signal; a compression/extension module which compresses and extends the video and audio signals in compression methods compliant with the plural standards; a format controlling module which generates formats compliant with the plural standards for the video and audio signals; a recording/reproducing module which records/reproduces the processed data into/from the recoding media including a BD, a DVD, an HDD, and an SD card; and a system controlling module which controls an operation of each block. In the video camera apparatus, the compression/extension module includes: a common compression/extension module common between the AVCHD standard and the BD standard, which performs a process of the H.264 compression method for the video signal and a process of the Dolby Digital compression method for the audio signal; and the format controlling module includes a common format generating module common between the AVCHD standard and the BD standard, which generates a format including data structures and directories, in compliance with the BDMV subset.

The present invention makes it possible to realize an information recording/reproducing apparatus and a video camera that correspond to various recording media and plural standards including high-definition recording and are excellent in usability within advantageously earlier stage.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an embodiment of a camera-integrated recording apparatus as an information recording/reproducing apparatus according to the present invention;

FIG. 2 is a diagram showing a configuration example of a compression/extension module compliant with recording formats of various media;

FIG. 3 is a diagram showing a configuration example of the compression/extension module compliant with various recording formats of an HDD medium;

FIG. 4 is a diagram showing a configuration example of a format controlling module compliant with various recording formats;

FIG. 5 is a diagram showing a directory configuration common between the AVCHD format and the BD format;

FIGS. 6A and 6B are diagrams showing the configurations of directories and files in the AVCHD format and the BD format by way of comparison;

FIG. 7 is a diagram showing a state in which a generation process of the AVCHD format and the BD format is separately performed for common parts and non-common parts;

FIG. 8 is a diagram for explaining the processing steps in a unique standard part;

FIG. 9 is a diagram for explaining a process in which data recorded into a DVD in the AVCHD format are recorded into a BD;

FIG. 10 is a diagram for explaining a process for recording data on an HDD into a DVD;

FIG. 11 is a diagram for explaining a process for recording data on an HDD into a BD; and

FIG. 12 is a diagram for explaining a process for recording data on an HDD into a semiconductor memory.

### DETAILED DESCRIPTION OF THE PREFERRED EMBODIMENTS

Hereinafter, an embodiment of the present invention will be described with reference to the drawings. In the following description, the term of “dubbing” includes both “copying” and “moving”.

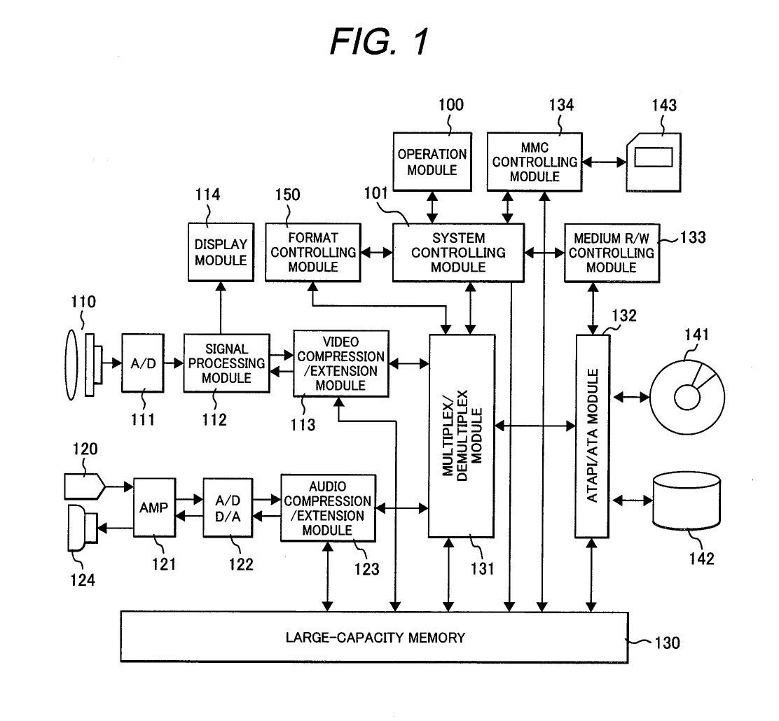

FIG. 1 is a block diagram showing an embodiment of a camera-integrated recording apparatus as an information recording/reproducing apparatus according to the present invention. First of all, a configuration of the whole apparatus will be described.

An operation module 100 operated by a user includes a recording/stop key, a zoom key, a selection key for selecting a recording mode. A system controlling module 101 controls a multiplex/demultiplex process or other various formats, and reading/writing of data from/into a medium. In addition, the system controlling module 101 integrally controls respective modules. An imaging module 110 includes an optical lens for imaging an image of a subject and a CCD sensor or a CMOS sensor that is a photoelectric conversion module for converting the imaged light into an electric signal. An A/D converter 111 converts the electric signal of video into a digital signal. A signal processing module 112 performs a process for converting image information converted into the digital signal, into a video signal. A video compression/extension module 113 compresses or extends the video signal in accordance with a predetermined coding method such as MPEG2 and H.264. A display module 114 displays the video. It should be noted that as the display module 114, a display module in a finder and a movable display module provided outside a casing of the video camera may be separately provided. A microphone 120 converts collected audio into an electric audio signal, and a speaker 124 outputs the audio. An amplifier (AMP) 121 amplifies the audio signal, and an A/D converter (D/A converter) 122 converts the electric signal of the audio into a digital signal. An audio compression/extension module 123 compresses or extends the digital audio in accordance with a predetermined coding method such as Dolby Digital and MPEG.

A multiplex/demultiplex module 131 multiplexes a compressed moving-image stream generated by the video compression/extension module 113 with a compressed audio stream generated by the audio compression/extension module 123. A large-capacity memory 130 temporarily stores image data compressed by the video compression/extension module 113, audio data compressed by the audio compression/extension module 123, and data obtained by multiplexing these data. An ATAPI/ATA module 132 is an interface module compliant with a specific standard. As recording media, an optical disc 141 such as a BD and a DVD, and an HDD (hard disc) 142 are mounted. When recording/reproducing data into/from the optical disc (BD or DVD) 141 or the HDD 142, a medium R/W controlling module 133 controls reading/writing of a data file of a moving image in a predetermined file format.

A format controlling module 150 discriminates the type of the recording medium so as to generate information of formats compliant with various standards such as the BDMV (Blu-ray Disk Movie)-s standard, the VR standard, and the VF standard. An MMC controlling module 134 is used when recording data into a card medium 143 such as an SD card and an MMC (Multi Media Card). Although a still image is usually recorded into the card medium 143, moving-image data can be recorded thereinto by converting the result obtained from the multiplex/demultiplex module 131 into a predetermined format.

The respective functions of the video compression/extension module 113, the audio compression/extension module 123, the multiplex/demultiplex module 131, the format controlling module 150, and the system controlling module 100 can be realized by, preferably, executing a program with a microprocessor. However, a part or all of these modules may be configured by using hardware. In FIG. 1, there are shown controlling lines and information lines that are deemed necessary for explanation, and all of the controlling and information lines in an actual apparatus are not necessarily shown. In an actual apparatus, it may be assumed that almost all constituent elements are coupled to each other.

Next, a recording operation of the camera-integrated recording apparatus according to the embodiment will be described.

When a moving-image shooting mode is selected by an operation of the operation module 100, the system controlling module 100 recognizes the selection so as to control the whole apparatus in the following manners. The mode of the imaging module 110 is switched into a moving-image signal generation mode. Video imaged by the optical lens is converted into an electric signal by the CCD sensor or the CMOS sensor, and the electric signal is converted into a digital signal by the A/D converter 111. Then, the digital signal is converted into video data by the signal processing module 112. Thereafter, the video data are compressed by the video compression/extension module 113 so as to be temporarily stored into the memory 130. In the compression process, the video data are sequentially converted into the compressed moving-image streams while transmitting or receiving the video data that are being in a compression process between the video compression/extension module 113 and the memory 130. On the other hand, audio collected by the microphone 120 is converted into a digital signal through the AMP 121 and the A/D converter 122, and then the digital signal is compressed by the audio compression/extension module 123. Then, the compressed signal is temporarily stored into the memory 130 as the compressed audio stream. Thereafter, the compressed moving-image stream and the compressed audio stream stored into the memory 130 are multiplexed by the multiplex/demultiplex module 131 so as to be temporarily stored into the memory 130 as multiplexed data.

The format controlling module 150 establishes a recording format compliant with a recording standard. The multiplexed data read from the memory 130 are recorded into the recording medium (DVD or BD) 141 and the HDD 142 in the established, predetermined recording format through the medium R/W controlling module 133 and the ATAPI/ATA module 132. In this case, the multiplexed data can be recorded into one of the media, or both of the media at the same time. The embodiment has characteristics in generation and management of the recording formats for plural standards. The format controlling module 150 manages data in a predetermined format, and the shot video is recorded into the recording medium for each scene of the video.

The recording format of the AVCHD standard and the recording format of the BD standard are similar in many points, and almost all controlling software modules (libraries) and hardware modules can be shared for use. Specifically, the constituent elements are shared, so that it is possible to provide a BD camera compatible with AVCHD with few new software and hardware added. Further, modules used in the conventional DVD standards are used, so that the BD camera is capable of recording/reproducing data into/from a conventional DVD. As described above, modules in common with AVCHD are used as assets in the BD camera, so that the development steps and period can be reduced, thus promptly realizing the camera.

Next, a concrete controlling method of the recording format will be described.

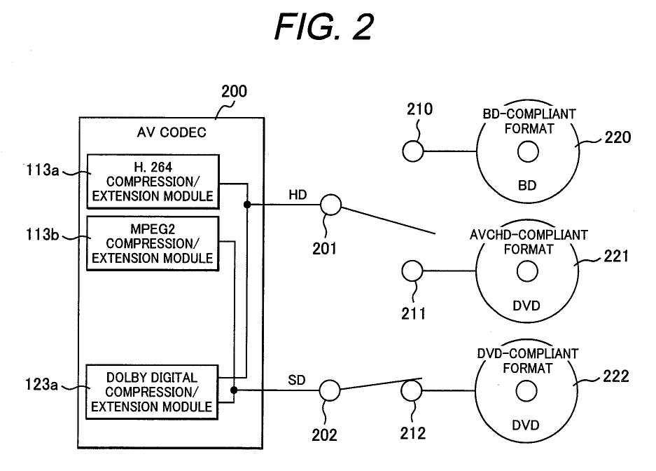

FIG. 2 is a diagram showing a configuration example of the compression/extension module compliant with the recording formats of the various media. The module is configured to share the functions of the video compression/extension module 113, the audio compression/extension module 123, and the multiplex/demultiplex module 131. An AV codec processing module 200 includes an H.264 compression/extension module 113a and an MPEG2 compression/extension module 113b as the video compression/extension module 113, and a Dolby Digital compression/extension module 123a as the audio compression/extension module 123. The AV codec processing module 200 is illustrated as an actual LSI. It is obvious that the AV codec processing module 200 may be configured as a block of software, or a coprocessor and the like may be mounted in an LSI. In that case, a preparatory process for downloading a program for operation is included. Input/output of a signal into/from the AV codec processing module 200 is performed through terminals 201 and 202. The terminal 201 is used when an image with the HD image quality is recorded, and the terminal 202 is used when an image with the SD image quality is recorded.

As recording media, FIG. 2 shows a case in which there are used a BD disc 220 into which data are recoded in the BD format, a DVD 221 into which data are recorded in the AVCHD format, and a DVD 222 into which data are recorded in the conventional DVD format (VR, VF, +VR, or the like). A terminal 210 shows a terminal for selecting a path when data are recorded into the BD disc 220, and each of terminals 211 and 212 shows a terminal for selecting a path when data are recoded into the DVD 211 or the DVD 222. However, one of the DVDs 221 and 222 is mounted and accommodated at the same position in a configuration of an actual apparatus, so that the terminals 211 and 212 are shared. In FIG. 2, a correspondence relation when the format is switched to another is shown.

When the SD recording into a DVD is performed, only a combination of an MPEG2 process and a Dolby Digital process is necessary. However, when the HD recording is performed, the H.264 codec is necessary. Therefore, when the HD recording is requested, the AV codec 200 outputs a combination of H.264 and Dolby Digital from the terminal 201. In addition, when the SD recording is requested, the AV codec 200 outputs a combination of MPEG2 and Dolby Digital from the terminal 202. In this case, the audio compression/extension module 123 is shared. For example, if a user requests to record data with the HD image quality, the BD format or the AVCHD format is required, so that the output terminal 201 is coupled to the terminal 210 or 211 on the media side so as to start the recording. If the user requests to record data into the conventional DVD, the terminal 202 is coupled to the terminal 212. If data with the SD image quality are recorded into the BD, the terminal 202 is coupled to the terminal 210, so that the recoding can be realized. Since disc information (the type of the medium and contents of the format recorded by management information) can be obtained when the disc is set to the video camera, the above-described connection switch (selection of path) can be automatically switched by the system controlling module 101 on the basis of the obtained information. Further, if the user selects a path through which an operation is to be limited (for example, when data with the HD image quality are recorded into the conventional DVD 222), it is possible to restrict so as not to record data through the path as needed.

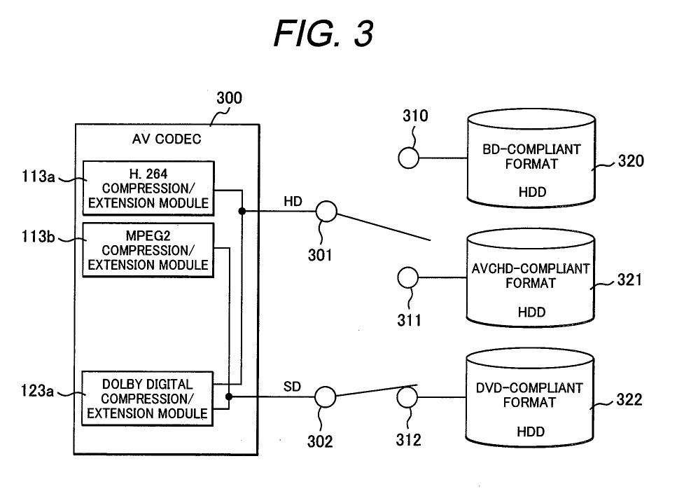

Next, FIG. 3 is a diagram showing a configuration example of the compression/extension module compliant with various recording formats where the recording medium is an HDD. All of recording media 320, 321, and 322 are HDDs, and are discriminated from each other on the basis of whether the recording format is the BD format, AVCHD format, or DVD-compliant format. The configuration of an AV codec 300 and respective terminals 301, 302, 310, 311, and 312 are the same as those in the case of FIG. 2, and the audio compression/extension module 123 is shared. It should be noted that the terminals 310, 311, and 312 are shared in an actual apparatus.

For example, if a user requests to record data with the HD image quality, the BD format or the AVCHD format is required, so that the terminal 301 is coupled to the terminal 310 or 311 so as to start the recording. If the user requests to record data in the conventional DVD format, the terminal 302 is coupled to the terminal 312. If data with the SD image quality are recorded in the BD format, the terminal 302 is coupled to the terminal 310, so that the recoding can be realized.

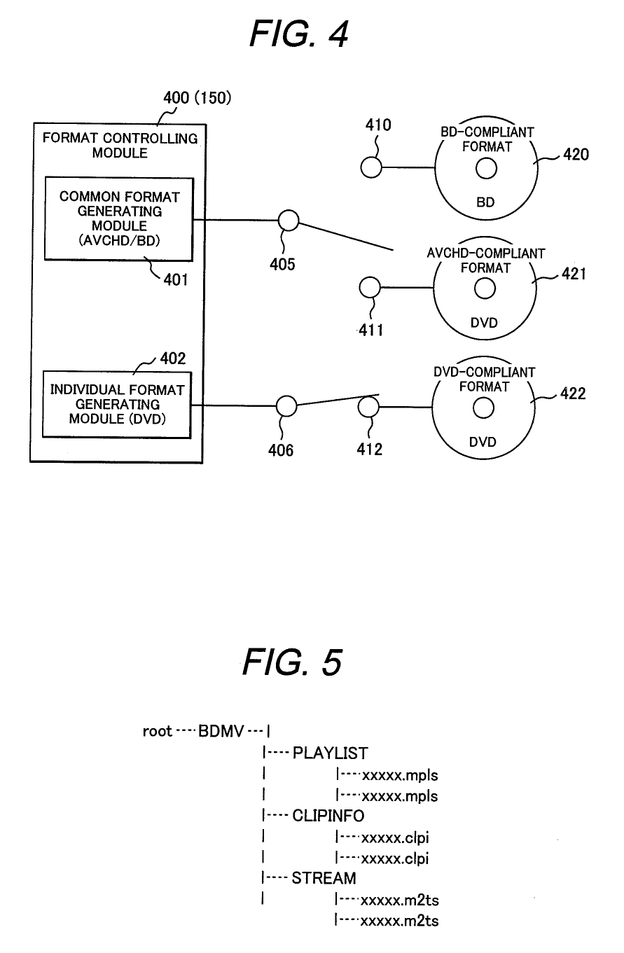

FIG. 4 is a diagram showing a configuration example of the format controlling module compliant with various recording formats. As recording media, FIG. 4 shows a case in which there are used a BD 420 into which data are recoded in the BD format, a DVD 421 into which data are recorded in the AVCHD format, and a DVD 422 into which data are recorded in the conventional DVD format, as similar to FIG. 2. A format controlling module 400 corresponds to the format controlling module 150 of FIG. 1, and generates a necessary format. The compressed signals from the AV codecs 200 and 300 of FIGS. 2 and 3 are input to the format controlling module 400.

The format controlling module 400 includes a common format generating module 401 and an individual format generating module 402. The common format generating module 401 generates a format (common specification) that is common between the AVCHD format and the BD format. The common specification includes, for example, a directory configuration and various management information.

FIG. 5 shows a concrete example of common parts of the directory configuration. The directory names “BDMV”, “PLAYLIST”, and the like that are indicated by capital letters are common between the AVCHD format and the BD format.

Further, a file system of a logic layer has common parts. Where data are recorded in the BD or AVCHD format, it is more preferable to record the data so as to satisfy the both standards. By recording the data in such a manner, the data recorded by the video camera have completely the same format, so that the data can be processed at a high speed when reproducing or dubbing the data.

On the other hand, the individual format generating module 402 generates a format that is not common (that is a non-common part). In this case, the DVD format is a part that is not common. Specifically, the VR format, the VF format, +VR format are generated. The VR format is used in the case of a DVD-RAM, the VF format is used in the case of the DVD-R, and the +VR format is used in the case of a DVD+RW and a DVD+R.

When a user performs the HD recording, the BD format or the AVCHD format is required. In the two formats, the directory configurations and the internal management information are almost the same, as described above, so that the common parts are preliminarily sorted, and are generated by the common format generating module 401. On the other hand, it is efficient if the non-common parts are generated by the individual format generating module 402 so as to be added to the common parts.

That is, if the common format generating module for generating the common specification parts is provided when the formats of plural standards are generated, the sizes of circuits, the amount of codes, and the number of development steps can be reduced by utilizing the common format generating module. Further, although three kinds (BD, AVCHD, and DVD) of format generating modules are essentially necessary, only two configurations of the generating module 401 for HD recording and the generating module 402 for SD recording are required by utilizing the common module as shown in FIG. 4. It is obvious that if the two configurations have insufficient functions, it is necessary to add corresponding software, but the number thereof is small.

As described above, by combining the switching of output of the AV codecs in FIGS. 2 and 3 with the switching of output of the format controlling module in FIG. 4, simpler control can be performed. Further, if processing circuits and software are provided as common assets, the configuration can be simplified and the number of development steps can be reduced by utilizing the assets. Accordingly, a video camera capable of recording an image with the HD image quality can be promptly provided for a user.

Next, a concrete method of generating and managing (controlling the directory configuration and management information files) a format in the AVCHD format and the BD format will be described.

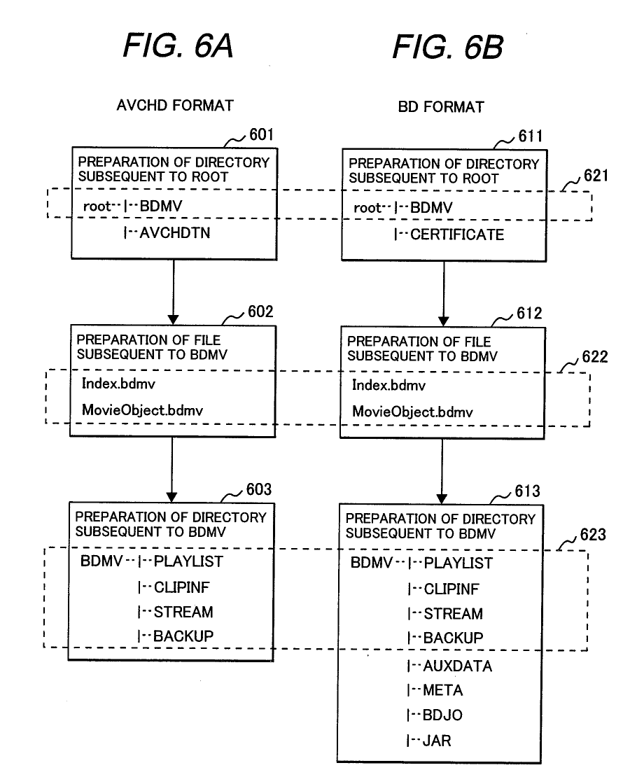

FIGS. 6A and 6B are diagrams showing the configurations of directories and files in the AVCHD format and the BD format by way of comparison. FIG. 6A shows a case of the AVCHD format, and FIG. 6B shows a case of the BD format.

The reference numeral 601 denotes generation of directories subsequent to root in the AVCHD format, and the directory names are “BDMV” and “AVCHDTN”. The reference numeral 611 denotes generation of directories subsequent to root in the BD format, and the directory names are “BDMV” and “CERTIFICATE”. In the both formats, a part indicated by the reference numeral 621 has the common directory name of “BDMV”.

The reference numeral 602 denotes generation of files subsequent to “BDMV” in the AVCHD format, and the file names are “Index.bdmv” and “MovieObject.bdmv”. The reference numeral 612 denotes generation of files subsequent to “BDMV” in the BD format, and the file names are “Index.bdmv” and “MovieObject.bdmv”. “Index.bdmv” is an essential file, and basic information such as information indicating what type of menu is present is managed. “MovieObject.bdmv” is also an essential file, and basic information such as information indicating which video source is to be reproduced is managed. In the both formats, a part indicated by the reference numeral 622 has the common file names of “Index.bdmv” and “MovieObject.bdmv”.

The reference numeral 603 denotes a configuration of directories subsequent to “BDMV” in the AVCHD format, and the reference numeral 613 denotes a configuration of directories subsequent to “BDMV” in the BD format. A part indicated by the reference numeral 623 has the common directory names which include “PLAYLIST”, “CLIPINF”, “STREAM”, and “BACKUP”. In the case of the BD format, “AUXDATA”, “META”, “BDJO”, and “JAR” are necessary as unique directory names.

Subsequent to “PLAYLIST”, “CLIPINF”, “STREAM”, and “BACKUP”, various types of management information files are present. Subsequent to “PLAYLIST”, a management file for storing the length of shot video and the like is present, and subsequent to “CLIPINF”, management information of shot stream information is present. Subsequent to “STREAM”, a shot stream file itself is stored. In “BACKUP”, the information such as “PLAYLIST” and “CLIPINF” is backed up. Three directories of “PLAYLIST”, “CLIPINF”, and “STREAM” and the information subsequent to these directories serve as basic information of shot contents. As described above, it can be found that basic parts (directory names and file names) necessary for shooting are common between the AVCHD format and the BD format.

Next, a method of effectively generating the format configuration shown in FIG. 6 will be described.

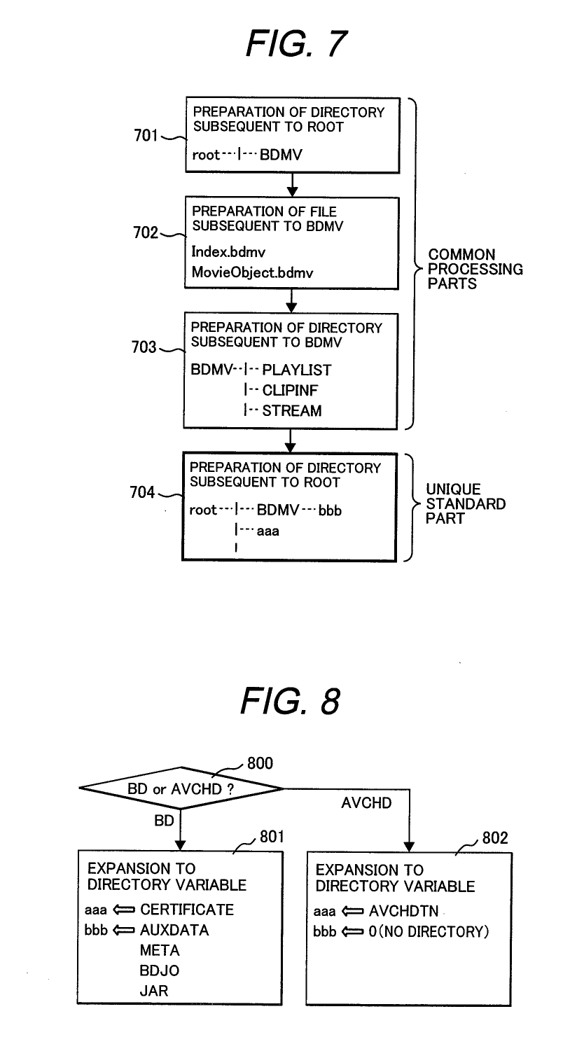

FIG. 7 is a diagram showing a state in which the generation process in the two format configurations is separately performed for common parts and non-common parts. The format configuration shown in FIG. 6 is divided into parts with the reference numerals 701, 702, and 703 that are common processes and a part with the reference numeral 704 that is not a common process (namely, a unique standard). In the common parts 701, 702, and 703 among these parts, the efficiency of the process can be enhanced by performing the same process irrespective of a format after video shooting is started.

On the other hand, in the unique standard part 704, information that is uniquely required depending on a format is preliminarily obtained, and the information is only expanded. Accordingly, the process of the unique part can be realized with a simple configuration without branches. In the process 704, generation of directories subsequent to root and generation of directories subsequent to BDMV are performed. In order to effectively execute this process, a variable aaa for storing a directory name arranged subsequent to root is provided as shown in FIG. 7. In addition, a variable bbb for storing directory information arranged subsequent to “BDMV” is provided. These variables are used for storing directory information, and thus may be arrays or tables in any format.

FIG. 8 is a diagram for explaining the processing steps in the unique standard part 704. In a determination step 800, a disc medium set to the camera and a format are determined. The BD process and the AVCHD process are started in accordance with the determination result. In the case of the BD format, the directory name of “CERTIFICATE” is stored into the variable aaa as shown in a step 801. In addition, “AUXDATA”, “META”, “BDJO, and “JAR” are stored into the variable bbb. On the other hand, in the case of the AVCHD format, “AVCHDTN” is stored into the variable aaa as shown in a step 802. Information (for example, 0) indicating that no directory is present is stored into the variable bbb.

In the determination step 800, the medium and the format contents can be confirmed when the disc is set to the camera, so that data are stored into the variables aaa and bbb at that timing. Accordingly, even if the process in FIG. 7 is executed at an arbitrary timing thereafter, an effective process can be performed by using the information already stored into the variables aaa and bbb without especially increasing branch processes. Where the disc is not formatted, the format determination in the determination step 800 may be performed at a timing when a user selects a formatting process.

Further, the processes 701 and 702 of the common parts may be performed, not for each shooting, at a timing of, for example, ejecting the disc or a timing when the camera is coupled to a PC through a USB. Because if the directory configuration is compliant with the standard when the disc is ejected from the camera or when information is read by using a PC, the processes 701 and 702 of the common parts are not required for each shooting. In addition, the directory, such as “BDMV” in the process 701, that need not be written again may be preliminarily prepared immediately after formatting. As similar to the above, if a directory that is not changed for each recording is present in a part of the process 704 of the unique part, it is more efficient that the directory is prepared at the time of disc formatting.

In the BD/HDD hybrid camera according to the embodiment, data can be recorded and stored into a disc in a data format with high compatibility only by the apparatus by using the functions of data conversion, dubbing and the like. Hereinafter, the dubbing function will be concretely described.

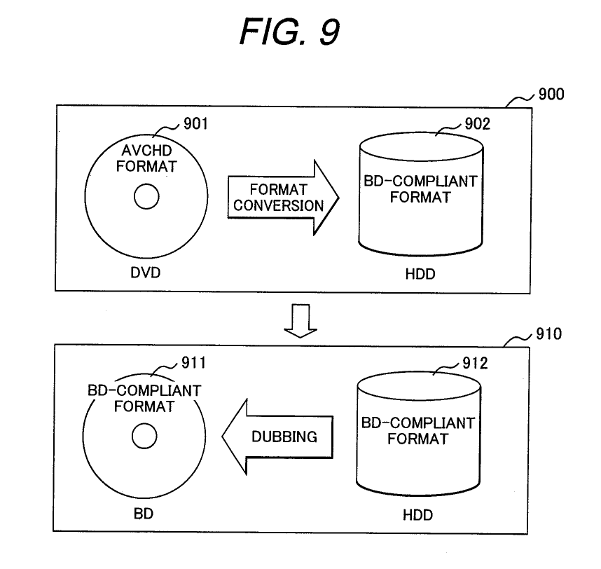

FIG. 9 is a diagram for explaining a process in which data recorded into a DVD disc in the AVCHD format are recorded into a BD disc. Specifically, data in the AVCHD format on a DVD disc are dubbed to a BD disc by using the BD/HDD hybrid camera.

A process 900 is a process in which data on a DVD 901 are dubbed to an HDD 902. The DVD 901 contains the data recorded in the AVCHD format, and the HDD 902 contains the data in the BD format after format conversion. Next, a process 910 is a process in which the data on an HDD 912 (902) that is converted in the process 900 are dubbed to a BD 911. The BD 911 contains the data recorded in the BD format.

The procedure of the process 900 will be described. First of all, a user sets the DVD disc 901 for AVCHD recording to the camera. Thereafter, data are dubbed to the HDD 902 while converting the data into the BD format by utilizing a menu (not shown) or a dedicated button (not shown). If UDF (Universal Disc Format) 2.5/2.6 is used at this time as a file system on the HDD 902, the conversion of the file format is not necessary, thus reducing the load (if the file system on the HDD is not UDF but FAT, the format conversion is necessary). Further, the recording format is shared between AVCHD and BD, so that the dubbing is simplified. That is, if the same formats compliant with the BDMV subset are generated at the time of recording between AVCHD and BD, the efficiency of the dubbing is improved. However, the formats include a different portion on the standard. For example, it is specified that for an extension data region that can be used by a user, information (ID) used is different depending on AVCHD and BD, so that only a simple dubbing may not be sufficient. However, almost all data, management information, and video data themselves can be dubbed if such a detail is excluded.

The procedure of the process 910 will be descried. If the format conversion and the dubbing are finished, the DVD disc 901 for AVCHD recording is ejected from the camera, and the BD disc 911 is set to the camera. Thereafter, the data are dubbed from the HDD 912 (902) to the BD 911 by utilizing a menu (not shown) or a dedicated button (not shown). In this case, the format of the HDD 912 is the BD format, so that a simple dubbing is sufficient. Therefore, the dubbing can be performed at a high speed.

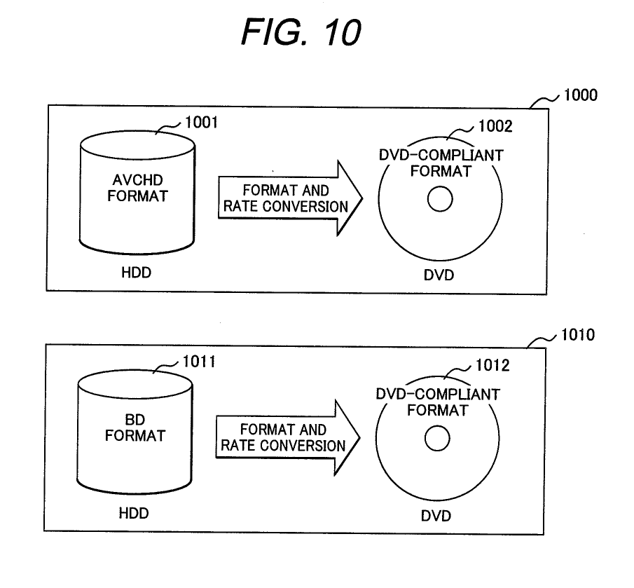

FIG. 10 is a diagram for explaining a process for recording data on an HDD into a DVD. In this case, the data with the HD image quality on the HDD are converted into the SD image quality before dubbing the data to the DVD disc with high compatibility. First of all, such an application will be mentioned. It is undeniable that the compatibility of the AVCHD and BD is lower than that of the DVD in view of the number of DVD players and recorders that have been marketed from the past. Therefore, if an AVCHD disc or a BD disc is sent to others, there is a high possibility that the data can not be reproduced on the reception side. Therefore, it is convenient for a user if a function of dubbing the data to a DVD with high compatibility is provided, although the HD image quality is converted into the SD image quality.

In FIG. 10, a process 1000 is a process in which data recorded in the AVCHD format into an HDD 1001 is recorded into a DVD 1002. The DVD 1002 contains the data recorded in the DVD format. In addition, a process 1010 is a process in which data recorded in the BD format into an HDD 1011 is recorded into a DVD 1012. The DVD 1012 similarly contains the data recorded in the DVD format.

The procedure of the process 1000 will be described. First of all, a user sets the DVD disc 1002 to the camera and uses a menu (not shown) or a dedicated button (not shown) in order to convert the AVCHD format of the HDD 1001 into the DVD format thereby to record the data into the DVD 1002. At this time, format conversion in accordance with the medium is necessary so that the AVCHD format is converted into VR (in the case of DVD-RAM, -RW), VF (in the case of DVD-R, -RW), and +VR (in the case of DVD+RW, +R). It is necessary to convert a TS (transport stream) in the AVCHD format into a PS (program stream) at the multiplexed packet level. Further, in order to comply with the standard, the codec needs to be changed. Specifically, the HD format of H.264 is transcoded into the SD format of MPEG2. Therefore, a re-encoding process is necessary. However, since no changes are needed for audio, conversion in a state of an ES (elementary stream) may be performed. At this time, it is possible to convert the rate together therewith. For example, the rate is converted from 384 Kbps into 256 Kbps. Although slight deterioration in audio quality is caused by the re-encoding, the re-encoding causes no problem in the camera application. The process 1010 is a case in which data are recorded into the HDD 1011 in the BD format, and the process thereof is the same as the process 1000.

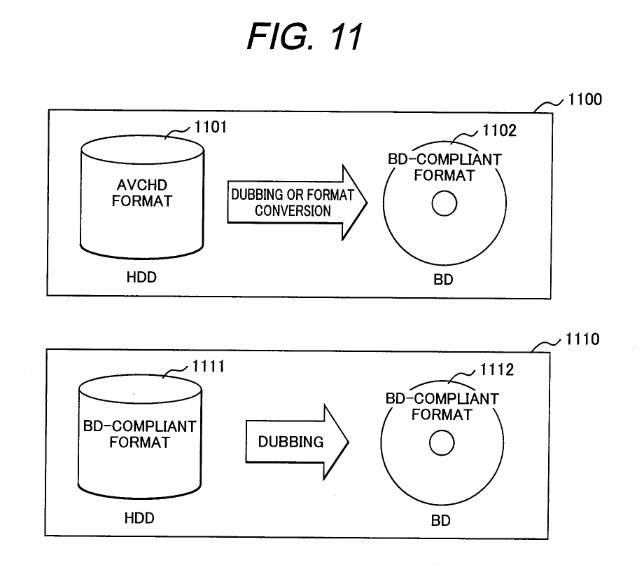

FIG. 11 is a diagram for explaining a process for recording data on an HDD into a BD. A process 1100 is a process in which data in the AVCHD format on an HDD 1101 are dubbed to a BD 1102. The BD 1102 contains the data in the BD format that is obtained after format conversion. This process is a reverse process of the process 900 in FIG. 9, and the explanation thereof will be omitted. Further, a process 1110 is a process in which data in the BD format on an HDD 1111 are dubbed to a BD 1112, and the format conversion is not performed. This process is the same as the process 910 in FIG. 9. In FIG. 9, although the process is performed in the course of the dubbing, the process can be performed only by the process 1110.

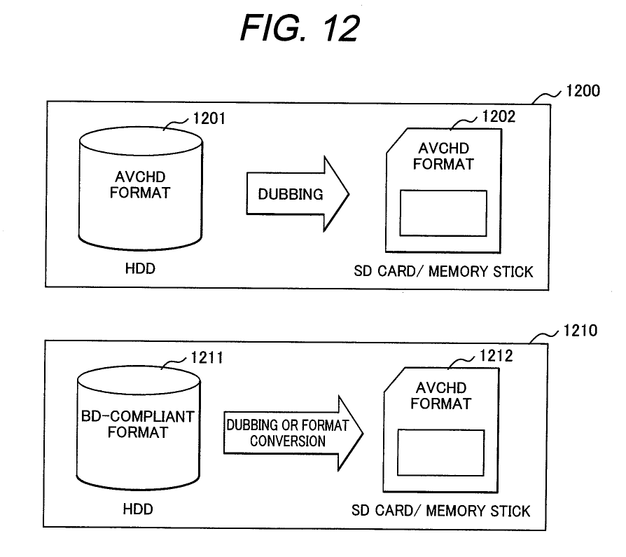

FIG. 12 is a diagram for explaining a process for recording data on an HDD into a semiconductor memory (an SD card, a memory stick or the like). A process 1200 is a process in which the data recorded in the AVCHD format into an HDD 1201 are dubbed to a semiconductor memory 1202. The semiconductor memory 1202 contains the data recorded in the AVCHD format. In addition, a process 1210 is a dubbing process in which data in the BD format recorded in an HDD 1211 are converted into the data in the AVCHD format then to be dubbed to a semiconductor memory 1212.

The procedure of the process will be described. First of all, a user sets the semiconductor memory to the camera. Thereafter, the data in the AVCHD format are dubbed to the semiconductor memory by utilizing a menu (not shown) or a dedicated button (not shown). In the case of the process 1200, since the format is the same, a simple dubbing is sufficient. In addition, in the case of the process 1210, if the data are recorded into the HDD in the BD format, the format part is dubbed as it is, and minimum format conversion is sufficient for the other parts.

As described above, in the HDD and DVD/BD hybrid camera, it is possible to easily dub data on an AVCHD disc to a BD disc by complying with the AVCHD format, and to dub the data to a DVD with high compatibility. Further, it is possible to convert (copy and move) data among a semiconductor memory, a DVD (including the AVCHD format), and a BD, thus improving the convenience of a user.

According to the embodiment described above, in development of a BD-compliant video camera compliant with, for example, the AVCHD standard, the number of development steps can be reduced, and it is possible to promptly provide a video camera capable of recording the HD image quality for a user. In addition, since data with the HD image quality can be recorded into not only a BD disc, but also a DVD in the AVCHD format, a user can enjoy the HD image quality by using a DVD disc that is less expensive than a BD disc. Accordingly, it is excellent in user-friendliness.

While we have shown and described several embodiments in accordance with our inventions, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

In the above embodiments each elements at least expressed as “module” can be realized by a hardware or a software or both to achieve the function and the operation explained in the part.

What is claimed is:

1. An information recording/reproducing apparatus adapted to a plurality of recording media and to record and/or reproduce data in compliance with a plurality of standards, comprising:
a compression/extension module which compresses and extends an information signal in compression methods compliant with the plurality of standards;
a format controlling module which generates formats compliant with the plurality of standards for the information signal; and
a recording/reproducing module which records/reproduces the processed data into/from the recoding media,
wherein the compression/extension module includes a common compression/extension module which performs a process of a compression method common in the plurality of standards, and
the format controlling module includes a common format generating module which performs a formatting process common in the plurality of standards.

2. The information recording/reproducing apparatus according to claim 1,
wherein the plurality of recording media include a DVD, a BD, an HDD, and a semiconductor memory, and
the standards for the DVD, the HDD, and the semiconductor memory include the AVCHD standard.

3. The information recording/reproducing apparatus according to claim 1,
wherein the common compression/extension module performs a process of the H.264 compression method for a video signal, and performs a process of the Dolby Digital compression method for an audio signal.

4. The information recording/reproducing apparatus according to claim 1,
wherein the common format generating module generates a format including common data structures and directories in compliance with the BDMV subset, and uses UDF as a file format.

5. The information recording/reproducing apparatus according to claim 4,
wherein the format controlling module further includes an individual format generating module which performs a formatting process of the unique standard, and
in the event of determination of the standard of the recording medium or formatting the recording medium, the individual format generating module obtains unique format information to be generated, and generates unique directories and management information files by utilizing the information.

6. The information recording/reproducing apparatus according to claim 1, further comprising:
a function of copying and moving data among the plurality of recording media and/or a function of recording data while performing data conversion compliant with the standards among the plurality of recording media.

7. The information recording/reproducing apparatus according to claim 6,
wherein in the event of data conversion between a format in the AVCHD standard and a format in the BD standard, common parts in directory configurations, management information of BDMV, and multiplexed video and audio streams are dubbed.

8. The information recording/reproducing apparatus according to claim 6,
wherein in the event of dubbing data recorded in the AVCHD standard into the DVD to the BD, the data in the AVCHD standard are converted into a format in the BD standard and dubbed to the HDD before recording the data in the HDD into the BD.

9. The information recording/reproducing apparatus according to claim 6,
wherein data in the AVCHD or BD standard recorded in the HDD are converted into a format in the DVD standard before recording the data into the DVD.

10. The information recording/reproducing apparatus according to claim 6,
wherein in the event of converting data in the BD standard recorded in the HDD into a format in the AVCHD standard before recording the data into the semiconductor memory, common parts in directory configurations, management information of BDMV, and multiplexed video and audio streams are dubbed.

11. A video camera apparatus which records shot video into a plurality of recording media, in compliance with a plurality of standards, comprising:
an imaging module which shoots a subject and obtains a video signal and an audio signal;
a compression/extension module which compresses and extends the video and audio signals in compression methods compliant with the plurality of standards;
a format controlling module which generates formats compliant with the plurality of standards for the video and audio signals;
a recording/reproducing module which records/reproduces the processed data into/from the recoding media including a BD, a DVD, an HDD, and an SD card; and
a system controlling module which controls an operation of each block,
wherein the compression/extension module includes a common compression/extension module common between the AVCHD standard and the BD standard which performs a process of the H.264 compression method for the video signal and performs a process of the Dolby Digital compression method for the audio signal, and
the format controlling module includes a common format generating module common between the AVCHD standard and the BD standard which generates a format including data structures and directories, in compliance with the BDMV subset.

12. The video camera apparatus according to claim 11,
wherein in the event of data conversion between a format in the AVCHD standard and a format in the BD standard, common formats generated by the common format generating module are dubbed.
